(19) United States
(12) Patent Application Publication
(10) Pub. No.: US 2024/0058994 A1
(43) Pub. Date: Feb. 22, 2024

(54) A METHOD OF RECYCLING POLY(VINYL BUTYRAL) FROM MULTILAYER POLY(VINYL BUTYRAL) SHEETS

(71) Applicant: SOLUTIA INC., ST. LOUIS, MO (US)

(72) Inventors: YINONG MA, LONGMEADOW, MA (US); HELEN THOMPSON, SOMERS, CT (US); BERT JOZEF CAMPO, OOST-VLAANDEREN (BE); JOHN JOSEPH D'ERRICO, GLASTONBURY, CT (US); PU ZHANG, SUFFIELD, CT (US); SUNGKYUN SOHN, LONGMEADOW, MA (US)

(73) Assignee: SOLUTIA INC., ST. LOUIS, MO (US)

(21) Appl. No.: 18/260,105

(22) PCT Filed: Jan. 7, 2022
(86) PCT No.: PCT/US2022/011518

§ 371 Date: Jun. 30, 2023

Related U.S. Application Data
(60) Provisional application No. 63/135,847, filed on Jan. 11, 2021.

(51) Int. Cl. B29B 17/04; B32B 17/10; B09B 3/35; B09B 3/80; B29B 17/02

(52) U.S. Cl. CPC B29B 17/0412; B32B 17/10761; B09B 3/35; B09B 3/80; B29B 17/02; B32B 17/10036; B09B 2101/75

(57) ABSTRACT

Processes are disclosed for recovering stiff poly(vinyl butyral) from a plasticized poly(vinyl butyral) multilayer sheet containing the stiff poly(vinyl butyral) and soft poly(vinyl butyral). The processes include grinding the plasticized poly(vinyl butyral) multilayer sheet to obtain a granulate; adding additional plasticizer to the granulate to remove at least a portion of the soft poly(vinyl butyral); and physically separating the granulate from the resulting solution.

### FIELD OF THE INVENTION

This disclosure is related to the field of recycling polymer interlayers for multiple layer glass panels having at least one polymer interlayer sheet with multiple poly(vinyl butyral) components.

### BACKGROUND OF INVENTION

Laminated safety glass used in automobile windshields and architectural safety glass is typically composed of two sheets of glass laminated together with a plasticized polymer interlayer between them. Poly (vinylbutyral) (“PVB”) generally is the main component in the polymer interlayer.

The poly(vinyl butyral) resin is combined with plasticizer, typically before melt extrusion to sheet. Poly(vinyl butyral) resin and the plasticizer are typically manufactured through synthesis processes starting with the use of non-renewable feedstocks. Poly(vinyl butyral) is obtained by reaction of poly(vinyl alcohol) and butyraldehyde. The properties of poly(vinyl butyral) are determined by its molecular structure, which is characterized by parameters such as molecular weight and distribution thereof, residual hydroxyl content, and residual acetate content.

In recent years, a growing volume of multi-layer poly(vinyl butyral) interlayers for laminated glass has been sold to the market and has been applied in laminated safety glass. A multi-layer interlayer can provide enhanced sound insulation, by the presence of a softer layer in the center of the sheet (the “core layer”). Typically, the core layer composition, in terms of the amount of plasticizer relative to the amount of polymer, is different from the composition of the outer layers (the “skin layers”). The plasticizer content is typically higher in the core layer than it is in the skin layers. To enable such differences in composition between the layers, the PVB compound in the core layer has a composition which is different from the PVB compound in the skin layers in terms of hydroxyl content, possibly also in terms of residual poly(vinyl acetate) content.

Conventional multilayer interlayers such as a trilayer acoustic interlayer contain a soft core layer consisting of a single poly(vinyl butyral) (“PVB”) resin having a low residual hydroxyl content and a high amount of a conventional plasticizer, and two stiff skin layers having significantly higher residual hydroxyl content (see, for example U.S. Pat. Nos. 5,340,654, 5,190,826, and 7,510,771). Interlayers having the reverse configuration, that is, with one stiff layer sandwiched between two more soft layers have been found to improve the impact performance of the glass panel and can also be designed for sound insulation.

The following offers a simplified description of the manner in which multiple layer glass panels are generally produced in combination with these interlayers. First, at least one polymer interlayer sheet (single or multilayer) is placed between two substrates and any excess interlayer is trimmed from the edges, creating an assembly. It is not uncommon for multiple polymer interlayer sheets, or a polymer interlayer sheet with multiple layers (or a combination of both), to be placed within the two substrates, creating a multiple layer glass panel with multiple polymer interlayers. Then, air is removed from the assembly by an applicable process or method known to one of skill in the art; e.g., through nip rollers, vacuum bag or another deairing mechanism. Additionally, the interlayer is partially press-bonded to the substrates by any method known to one of ordinary skill in the art. In a last step, in order to form a final unitary structure, this preliminary bonding is rendered more permanent by a high-temperature and -pressure lamination process, or any other method known to one of ordinary skill in the art such as, but not limited to, autoclaving.

Trims or off-grade homogeneous poly(vinyl butyral) sheet products can be re-used in the sheet manufacturing process. After grinding, chips or flakes can be added again to the feed of the extrusion process. The PVB raw material can also be regained from laminated glass after it has served its purpose in an actual application. See U.S. Pat. Publn. No. US2009/0209667. However, the presence of the core layer leads to a certain visual defect upon re-extrusion when applying such practices to a multi-layer sheet. Due to the differences in poly(vinyl butyral) composition between PVB compounds in the skin and core layers, these materials do not mix well in the melt phase. This causes a specific type of haze to be visible in the laminated glass containing a PVB sheet in which pieces of a multi-layer sheet have been used in the raw material feed, which makes a product with inferior visual quality that is not appropriate for sales in the market.

The recycling of poly(vinyl butyral) multi-layer sheet from off grade finished sheet products that can't be re-used, and from laminated glass that has served its primary function and is being discarded, can be an economic and ecological step forward. It is likely less costly to recycle the finished sheet products, as compared to producing virgin poly(vinyl butyral) resin, while reducing the environmental footprint of poly(vinyl butyral) resin and sheet production. Maximizing scrap reuse is thus not only a competitive advantage, but also an environmentally sound practice.

U.S. Pat. Publn. No. 2003/0191202 discloses a method for separating target polymers and their additives from a material containing polymers, as a result of which the recovery both of the target polymers and of the additives is made possible. Based on the principle of a selective precipitation, the target polymer is precipitated and subsequently separated from the additives present in solution and dissolved foreign polymers. The separation of the additives from the solution is effected in a further step.

U.S. Pat. Publn. No. US 2009/0209667 discloses a method of recycling poly(vinyl butyral) resin, and incorporating that poly(vinyl butyral) resin into laminated glass and other articles. Poly(vinyl butyral) resin is recovered from discarded laminated glass through a well-defined process, that includes the steps of granulation of the laminated glass, solvent extraction of plasticizer and impurities, dissolution of poly(vinyl butyral), pre-filtration of insoluble contaminants, color removal via adsorption or bleaching, post-filtration of carbon particles, precipitation of poly(vinyl butyral), and washing, stabilization, and drying of poly(vinyl butyral) resin. In one embodiment, a method is disclosed to separate two poly(vinylbutyral) resins from a single batch of granules. For this embodiment, a solvent is chosen for the dissolution step that selectively dissolves at a suitable temperature a first poly(vinylbutyral) resin and not a second poly(vinyl butyral) resin.

There remains a need for methods of recycling PVB scrap material.

### SUMMARY OF INVENTION

In one aspect, the invention relates to processes for recovering stiff poly(vinyl butyral) from a plasticized poly(vinyl butyral) multilayer sheet containing a stiff poly(vinyl butyral) and a soft poly(vinyl butyral). According to one aspect of the invention, the processes will include a step of grinding the plasticized poly(vinyl butyral) multilayer sheet to obtain a poly(vinyl butyral) granulate. To this granulate may be added additional plasticizer to remove at least a portion of the soft poly(vinyl butyral) from the poly(vinyl butyral) granulate such that the granulate is enriched in the stiff poly(vinyl butyral). According to a further aspect, the granulate enriched in the stiff poly(vinyl butyral), may be separated from the soft poly(vinyl butyral) and additional plasticizer, for example, using one or more techniques selected from decanting, filtering, or centrifuging, leaving a varnish that comprises the soft poly(vinyl butyral) and additional plasticizer.

In one aspect, the processes of the invention may further include one or more steps of adding further additional plasticizer to the granulate to remove an additional portion of the soft poly(vinyl butyral) from the granulate, and thereafter separating the granulate from the additional portion of the soft poly(vinyl butyral) and the further additional plasticizer using one or more techniques selected from decanting, filtering, or centrifuging, leaving a varnish that comprises the additional portion of the soft poly(vinyl butyral) and the further additional plasticizers.

According to further aspects of the invention, the varnishes obtained are used to produce poly(vinyl butyral) interlayers.

Further aspects of the invention are as disclosed and claimed herein.

### DETAILED DESCRIPTION

Thus, in one aspect, the invention relates to processes for recovering stiff poly(vinyl butyral) from a plasticized poly(vinyl butyral) multilayer sheet containing the stiff poly(vinyl butyral) and soft poly(vinyl butyral). According to the invention, the processes may comprise a step of grinding the plasticized poly(vinyl butyral) multilayer sheet to obtain a poly(vinyl butyral) granulate. This granulate may be in the form of flakes, chips, or the like, without being at all limiting.

The invention may further comprise adding additional plasticizer to the poly(vinyl butyral) granulate to wash or remove at least a portion of the soft poly(vinyl butyral) from the poly(vinyl butyral) granulate such that the granulate is enriched in the stiff poly(vinyl butyral). This granulate enriched in the stiff poly(vinyl butyral) will thus be in solid form, facilitating separation of the granulate from the resulting soft poly(vinyl butyral) and additional plasticizer. The invention thus will also comprise separating the granulate enriched in the stiff poly(vinyl butyral) from the soft poly(vinyl butyral) and additional plasticizer, described herein as varnish, for example using one or more techniques selected from decanting, filtering, or centrifuging.

In a further aspect, the invention may further include one or more additional steps of adding further additional plasticizer to the granulate to remove an additional portion of the soft poly(vinyl butyral) from the granulate, and afterward separating the granulate from the additional portion of the soft poly(vinyl butyral) and the further additional plasticizer varnish using one or more techniques selected from decanting, filtering, or centrifuging. In each of the steps according to the invention, the additional plasticizer used may be the same or different than the plasticizer that is present in the plasticized poly(vinyl butyral) multilayer sheet.

Thus, as used herein, the term “varnish” is used to describe the resulting soft poly(vinyl butyral) and additional plasticizer when a granulate has been enriched in the stiff poly(vinyl butyral) granulate by use of a plasticizer.

We have surprisingly discovered that plasticizers such as those typically used to plasticize PVB may be used to selectively wash away a portion of the soft poly(vinyl butyral)s from the granulated poly(vinyl butyral) mixtures to obtain a granulate enriched in stiff poly(vinyl butyral) and a varnish which may be used to produce a poly(vinyl butyral) interlayer.

In one aspect, according to any of the preceding aspects, the soft poly(vinyl butyral) may have a residual hydroxyl content from about 8% to about 12%. In yet another aspect, the stiff poly(vinyl butyral) may have a residual hydroxyl content of from about 15% to about 25%.

In a further aspect, according to any of the preceding aspects, the plasticized poly(vinyl butyral) multilayer sheet may comprise triethylene glycol bis(2-ethylhexanoate) present as a plasticizer.

In yet another aspect, according to any of the preceding aspects, according to any of the preceding aspects, the plasticized poly(vinyl butyral) multilayer sheet may further comprise dihexyladipate or bis(2-ethylhexyl)adipate or another convenient substance such as Benzoflex 9-88 benzoate esters present as a plasticizer.

In another aspect, according to any of the preceding aspects, the additional plasticizer is selected from one or more of esters of a polybasic acid or a polyhydric alcohol. In a further aspect, the additional plasticizer may be selected from one or more of: triethylene glycol bis(2-ethylhexanoate), tetraethylene glycol bis(2-ethylhexanoate), triethylene glycol bis(2-ethylbutyrate), triethylene glycol diheptanoate, tetraethylene glycol diheptanoate, dihexyl adipate, bis(2-ethylhexyl)adipate, bis(2-ethoxyethyl)adipate, dioctyl adipate, hexyl cyclohexyladipate, diisononyl adipate, heptylnonyl adipate, dibutyl sebacate, polymeric adipates, a soybean oil, or an epoxidized soybean oil.

In one aspect, according to any of the preceding aspects, the triethylene glycol bis(2-ethylhexanoate) is present in the soft poly(vinyl butyral) in an amount from about 60 phr to about 100 phr. In another aspect, the additional plasticizer added to the poly(vinyl butyral) granulate in step b) comprises triethylene glycol bis(2-ethylhexanoate).

In a further aspect, according to any of the preceding aspects, the difference between the residual hydroxyl content of the soft poly(vinyl butyral) and the residual hydroxyl content of the stiff poly(vinyl butyral) is at least 4.0 weight percent.

In yet another aspect, according to any of the preceding aspects, the stiff poly(vinyl butyral) contained in the plasticized poly(vinyl butyral) multilayer sheet comprises from about 30 phr to about 45 phr plasticizer.

In one aspect, according to any of the preceding aspects, the soft poly(vinyl butyral) may be isolated from the mixture of soft poly(vinyl butyral) and additional plasticizer resulting from step b) to one or more of sedimentation, filtration, centrifugation, evaporation, or precipitation to isolate the soft poly(vinyl butyral). In another aspect, the invention relates to a poly(vinyl butyral) sheet comprising the isolated soft poly(vinyl butyral), as well as to a laminated glass comprising this poly(vinyl butyral) sheet.

In a further aspect, according to any of the preceding aspects, the varnish of soft poly(vinyl butyral) and plasticizer obtained may be used directly, optionally with the removal of water, without first isolating the soft poly(vinyl butyral) from the plasticizer, to produce a poly(vinyl butyral) sheet or interlayer comprising the varnish.

In yet another aspect, according to any of the preceding aspects, the invention relates to a poly(vinyl butyral) sheet comprising separated granulates enriched in the stiff poly(vinyl butyral) recovered according to the process of the invention. In yet another aspect, the invention relates to a laminated glass comprising these poly(vinyl butyral) sheets comprising granulates enriched in the stiff poly(vinyl butyral).

In yet another aspect, according to any of the preceding aspects, the processes may further comprise subjecting the varnish of soft poly(vinyl butyral) and additional plasticizer to one or more of sedimentation, filtration, centrifugation, evaporation, or precipitation to isolate the soft poly(vinyl butyral).

In a further aspect, according to any of the preceding aspects, the processes may further comprise adding the varnish of soft poly(vinyl butyral) and additional plasticizer to a poly(vinyl butyral) composition.

In yet a further aspect, according to any of the preceding aspects, the processes may further comprise forming the poly(vinyl butyral) composition into a sheet.

In another aspect, according to any of the preceding aspects, the processes may further comprise adding the varnish of soft poly(vinyl butyral) and additional plasticizer to a poly(vinyl butyral) composition comprising a whitener to form a translucent interlayer.

In yet another aspect, according to any of the preceding aspects, the processes may further comprise adding the varnish of soft poly(vinyl butyral) and additional plasticizer to a clear poly(vinyl butyral) formulation.

In yet another aspect, according to any of the preceding aspects, the invention relates to a poly(vinyl butyral) sheet comprising the isolated soft poly(vinyl butyral) according to any of the preceding aspects, In yet another aspect, the invention relates to a laminated glass comprising the poly(vinyl butyral) sheet according to any of the preceding aspects.

In yet another aspect, according to any of the preceding aspects, the invention may relate to a poly(vinyl butyral) sheet comprising the separated granulate enriched in the stiff poly(vinyl butyral) of any of the preceding aspects.

In yet another aspect, according to any of the preceding aspects, the invention may relate to a laminated glass comprising the poly(vinyl butyral) sheet of any of the preceding aspects.

The term “stiff poly(vinyl butyral)” refers to a poly(vinyl butyral) resin, or a blend of poly(vinyl butyral) resins, that is significantly stiffer than “soft poly(vinyl butyral),” typically forming a skin or stiff layer of a multilayer poly(vinyl butyral) multilayer sheet, as further described herein.

The term “soft poly(vinyl butyral)” refers to a poly(vinyl butyral) resin, or a blend of poly(vinyl butyral) resins, that is significantly softer than “stiff poly(vinyl butyral),” typically forming a core or soft layer of a multilayer poly(vinyl butyral) multilayer sheet, as further described herein. The soft or core poly(vinyl butyral) layer is typically sandwiched between two stiff or skin poly(vinyl butyral) layers to form a multilayer poly(vinyl butyral) multilayer sheet.

The term “plasticizer” as used herein refers generally to a molecule or blend of molecules, as further described herein, that plasticizes a polymer at lower plasticizer content, specifically poly(vinyl butyral), thereby softening it. Further, the plasticizers, useful according to the invention as additional plasticizers, help remove the soft poly(vinyl butyral)s from the granulated poly(vinyl butyral) mixtures by selectively washing or partially dissolving the soft poly(vinyl butyral) when present as additional plasticizer in higher amounts, due to the higher affinity or compatibility of the core layer for the plasticizer, as evidenced in part by its lower residual hydroxyl content.

In some embodiments, the additional plasticizer has a hydrocarbon segment of fewer than 20, fewer than 15, fewer than 12, or fewer than 10 carbon atoms. Suitable additional plasticizers for use according to the invention include esters of a polybasic acid or a polyhydric alcohol, among others. Suitable plasticizers include, for example, triethylene glycol bis(2-ethylhexanoate) (“3-GEH”), tetraethylene glycol bis(2-ethylhexanoate), triethylene glycol bis(2-ethylbutyrate), triethylene glycol diheptanoate, tetraethylene glycol diheptanoate, dihexyl adipate, bis(2-ethylhexyl)adipate, dioctyl adipate, hexyl cyclohexyladipate, diisononyl adipate, heptylnonyl adipate, dibutyl sebacate, polymeric adipates, soybean oils, and epoxidized soybean oils, and mixtures thereof. A more preferred plasticizer is 3-GEH. Additionally, plasticizers that are compatible in high temperatures may be preferred to further increase the flow of the interlayer.

The term “poly(vinyl butyral) multilayer sheet,” as used herein, refers to a sheet comprised of different layers of poly(vinyl butyral) resins, typically a soft or core layer, having a stiff, or skin, layer on each side of the core layer. The poly(vinyl butyral) multilayer sheets of the invention thus comprise at least one soft poly(vinyl butyral) and at least one stiff poly(vinyl butyral).

When we say that the poly(vinyl butyral) multilayer sheet is ground to obtain a granulated poly(vinyl butyral) mixture, we mean that it is reduced in size by any suitable means, for example a grinder, to obtain granulates, chips, flakes, or the like, all of which may be considered granulates according to the invention. In this granulation step, the granulation can be performed using any suitable device, which can be, for example, a commercial granulator such as a Granutec granulator (East Douglas, Mass., USA). The scrap is granulated to reduce the particle size. Granulation of scrap can result in individual granulates that have a long dimension of less than 2.6 centimeters, or 0.1 to 1.0 centimeters, or 0.4 to 0.8 centimeters. While granulates above 2.6 centimeters in size can be used, it is generally desirable to granulate the sheet to a smaller size, which results in a greater total granulate surface area. At any point during granulation, the granulated flakes can be sifted to remove contaminants freed from the poly(vinyl butyral).

When we say that additional plasticizer is added to the poly(vinyl butyral) granulate, we mean that the plasticizer added in this step is in addition to the plasticizer contained in the plasticized poly(vinyl butyral) multilayer sheet. Indeed, both the soft poly(vinyl butyral) and the stiff poly(vinyl butyral) will already contain plasticizer. The additional plasticizer may be the same plasticizer present in the soft poly(vinyl butyral) and/or the stiff poly(vinyl butyral), or it may be different than that present in the soft poly(vinyl butyral) and/or the stiff poly(vinyl butyral). The amount of additional plasticizer added is sufficient to assist in removing or washing at least a portion of the soft poly(vinyl butyral) from the poly(vinyl butyral) granulates to obtain a soft poly(vinyl butyral) and plasticizer varnish.

When we say that at least a portion of the soft poly(vinyl butyral) is removed from the poly(vinyl butyral) granulates, we mean that a portion of the soft poly(vinyl butyral) is washed or dissolved from the granulates. The granulates may thereafter be separated from the soft poly(vinyl butyral) and additional plasticizer according to one or more of the following techniques, as further described herein: decanting, filtering, or centrifuging. Alternatively, the varnish may be used directly to form a poly(vinyl butyral) layer or sheet, or optionally a portion of the additional plasticizer and/or water may be separated from the varnish prior to forming a poly(vinyl butyral) sheet or layer from the varnish.

When we say that the granulates are enriched in the stiff poly(vinyl butyral), we mean that the relative amount of the stiff poly(vinyl butyral) in the granulates is higher than it was before a portion of the soft poly(vinyl butyral) was washed from the granulates.

In one aspect, the soft or core poly(vinyl butyral) or blend of soft poly(vinyl butyral)s, may have a residual hydroxyl content, as further described herein, from about 5% to about 15%. Alternatively, the residual hydroxyl content of the core poly(vinyl butyral) may be from about 7% to about 13, or from 8% to 12%, or as further described herein.

In one aspect, the soft or core poly(vinyl butyral) or blend of soft poly(vinyl butyral)s, may have a residual acetate content, as further described herein, from about 0% to about 18%. Alternatively, the residual acetate content may be less than 10%, or less than 5%, or less than 2%, or less than 1%, or as further described herein.

The amount of plasticizer in the soft or core poly(vinyl butyral) or a blend of soft poly(vinyl butyral), may be from about 50 phr to about 150 phr, or from 55 phr to 120 phr, or from 60 to 100 phr.

In another aspect, the stiff poly(vinyl butyral) or blend of stiff poly(vinyl butyral)s, may have a residual hydroxyl content, as further described herein, from about 12% to about 28%. Alternatively, the residual hydroxyl content of the stiff poly(vinyl butyral) may be from about 15% to about 25%, or from 18% to 20%, or as further described herein.

In another aspect, the stiff poly(vinyl butyral) or blend of stiff poly(vinyl butyral)s, may have a residual acetate content, as further described herein, from about 0% to about 18%. Alternatively, the residual acetate content of the stiff poly(vinyl butyral) may be less than 10%, or less than 5%, or less than 2%, or less than 1%, or as further described herein.

In other aspects, the residual hydroxyl content of the core layer can be the same as, greater than, or less than the residual hydroxyl content of the resin in the skin layer. In various embodiments, the core resin, or skin resin or both of these resins, may comprise less than 30 wt. % residual ester groups, less than 25 wt. % residual ester groups, less than 20 wt. %, less than 15 wt. %, less than 13 wt. %, less than 10 wt. %, less than 7 wt. %, less than 5 wt. %, or less than 1 wt. % residual ester groups calculated as polyvinyl ester, e.g., acetate, with the balance being an acetal, such as butyraldehyde acetal, but optionally being other acetal groups, such as an isobutyraldehyde acetal group, a 2-ethyl hexanal acetal group, or a mix of any two of butyraldehyde acetal, isobutyraldehyde acetal, and 2-ethyl hexanal acetal groups, or as discussed elsewhere herein.

In an embodiment, the multilayered interlayers may comprise: a first skin polymer layer comprising plasticized poly(vinyl butyral) having a molecular weight of less than about 140,000 Daltons; a second core polymer layer comprising plasticized poly(vinyl butyral) having a molecular weight of greater than about 140,000 Daltons; and a third skin polymer layer comprising plasticized poly(vinyl butyral) having a molecular weight of less than about 140,000 Daltons. The second polymer layer is disposed between the first polymer layer and the third polymer layer, resulting in two skin layers and a central core layer.

In various embodiments of interlayers of the present disclosure, the interlayer may comprise about 30 to about 60 phr (parts per hundred parts resin) total plasticizer. While the total plasticizer content is indicated above, the plasticizer content in the skin layer(s) or core layer(s) can be different from the total plasticizer content. In addition, the skin layer(s) and core layer(s) can have different plasticizer contents, as each respective layer's plasticizer content at the equilibrium state is determined at least in part by its respective residual hydroxyl content. For example, at equilibrium the interlayer could comprise two skin layers, each with 38 phr plasticizer, and a core layer with 75 phr plasticizer, for a total plasticizer amount for the interlayer of about 54.3 phr when the combined skin layer thickness equals that of the core layer. For thicker or thinner skin layers, the total plasticizer amount for the interlayer may change accordingly.

In other aspects, the amount of plasticizer in the stiff or skin poly(vinyl butyral) or blend of soft poly(vinyl butyral)s may be from about 20 phr to about 60 phr, or from 25 phr to 50 phr, or from 30 to 45 phr.

In a further aspect, the difference between the residual hydroxyl content of the soft poly(vinyl butyral) and the residual hydroxyl content of the stiff poly(vinyl butyral) is at least 6%, or at least 5%, or at least 4%, or from 4% to 8%, or from 5% to 10%, or as further described herein.

Thus, in various embodiments, the residual hydroxyl contents of the poly(vinyl butyral) resins for skin layer(s) and core layer(s) may be different. The resin for the core layer(s), for example, can comprise about 9 to about 18 weight percent (wt. %) residual hydroxyl groups calculated as PVOH, about 9 to about 16 wt. % residual hydroxyl groups calculated as PVOH, or about 9 to about 14 wt. % residual hydroxyl groups calculated as PVOH. The resin for the skin layer(s), for example, can comprise about 13 to about 35 weight percent (wt. %) residual hydroxyl groups calculated as PVOH, about 13 to about 30 wt. % residual hydroxyl groups calculated as PVOH, or about 15 to about 22 wt. % residual hydroxyl groups calculated as PVOH; and, for certain embodiments, about 17.25 to about 22.25 wt. residual hydroxyl groups calculated as PVOH, or as described elsewhere herein. The resin for the core layer(s) or for the skin layer(s) or for both the skin layer(s) and core layer(s) can also comprise less than 20 wt. % residual ester groups, less than 15 wt. %, less than 13 wt. %, less than 11 wt. %, less than 9 wt. %, less than 7 wt. %, less than 5 wt. %, or less than 1 wt. % residual ester groups calculated as polyvinyl ester, e.g., acetate, with the balance being an acetal, preferably butyraldehyde acetal, but optionally including other acetal groups in a minor amount, for example, a 2-ethyl hexanal group (see, for example, U.S. Pat. No. 5,137,954, the entire disclosure of which is incorporated herein by reference).

In one aspect, the soft poly(vinyl butyral), the stiff poly(vinyl butyral), and/or the plasticized poly(vinyl butyral) multilayer sheet, or any other poly(vinyl butyral) described herein, may include a plasticizer selected from one or more of dipropylene glycol dibenzoate, tripropylene glycol dibenzoate, polypropylene glycol dibenzoate, isodecyl benzoate, 2-ethylhexyl benzoate, diethylene glycol benzoate, butoxyethyl benzoate, butoxyethyoxyethyl benzoate, butoxyethoxyethoxyethyl benzoate, propylene glycol dibenzoate, 2,2,4-trimethyl-1,3-pentanediol dibenzoate, 2,2,4-trimethyl-1,3-pentanediol benzoate isobutyrate, 1,3-butanediol dibenzoate, diethylene glycol di-o-toluate, triethylene glycol di-o-toluate, dipropylene glycol di-o-toluate, 1,2-octyl dibenzoate, tri-2-ethylhexyl trimellitate, di-2-ethylhexyl terephthalate, bis-phenol A bis(2-ethylhexaonate), di-(butoxyethyl) terephthalate, di-(butoxyethyoxyethyl) terephthalate, bis(2-ethoxyethyl)adipate, or as further described herein.

In various aspects, the additional plasticizer added may comprise one or more of dipropylene glycol dibenzoate, tripropylene glycol dibenzoate, polypropylene glycol dibenzoate, isodecyl benzoate, 2-ethylhexyl benzoate, diethylene glycol benzoate, butoxyethyl benzoate, butoxyethyoxyethyl benzoate, butoxyethoxyethoxyethyl benzoate, propylene glycol dibenzoate, 2,2,4-trimethyl-1,3-pentanediol dibenzoate, 2,2,4-trimethyl-1,3-pentanediol benzoate isobutyrate, 1,3-butanediol dibenzoate, diethylene glycol di-o-toluate, triethylene glycol di-o-toluate, dipropylene glycol di-o-toluate, 1,2-octyl dibenzoate, tri-2-ethylhexyl trimellitate, di-2-ethylhexyl terephthalate, bis-phenol A bis(2-ethylhexaonate), di-(butoxyethyl) terephthalate, di-(butoxyethyoxyethyl) terephthalate, or as further described herein, and may be the same or different than the plasticizer in the poly(vinyl butyral)s as just described, as further described herein. Further plasticizers suitable as the additional plasticizer or the plasticizer in the soft poly(vinyl butyral) are described elsewhere herein.

As noted, the poly(vinyl butyral) multilayer sheets of the invention typically comprise a stiff poly(vinyl butyral) layer and a soft poly(vinyl butyral) layer. As noted, the core layer typically comprises soft poly(vinyl butyral) sandwiched between stiff poly(vinyl butyral) skin layers to form the poly(vinyl butyral) multilayer sheets of the invention.

In one aspect, the amount of additional plasticizer added to the poly(vinyl butyral) granulate is sufficient to wash, extract, or selectively dissolve a portion of the soft poly(vinyl butyral).

In another aspect, the amount of additional plasticizer added to the poly(vinyl butyral) granulate is sufficient to suspend the stiff poly(vinyl butyral) granulates of the mixture, thus forming a stiff poly(vinyl butyral) suspension.

In yet another aspect, the additional plasticizer is added to the poly(vinyl butyral) granulate in a continuous process, for example to form a countercurrent process, to remove at least a portion of the soft poly(vinyl butyral) from the poly(vinyl butyral) granulate such that the granulate is enriched in the stiff poly(vinyl butyral). This granulate may then be separated from the resulting varnish mixture of the soft poly(vinyl butyral) and the additional plasticizer, or the varnish may be used without separating the additional plasticizer from the soft poly(vinyl butyral), or only partially separating the additional plasticizer from the soft poly(vinyl butyral), or only separating water from the mixture.

In a further aspect of the invention, the processes may comprise, after the physically separating step, further steps of subjecting the soft poly(vinyl butyral) from the resulting mixture of the soft poly(vinyl butyral) and the additional plasticizer to one or more of sedimentation, filtration, centrifugation, evaporation, or precipitation to isolate the soft poly(vinyl butyral).

In further aspects, the invention relates to poly(vinyl butyral) sheets that comprise the isolated stiff poly(vinyl butyral), and laminated glass comprising these poly(vinyl butyral) sheets.

In further aspects, the invention relates to poly(vinyl butyral) sheets that comprise the soft poly(vinyl butyral), and laminated glass comprising these poly(vinyl butyral) sheets, whether or not the soft poly(vinyl butyral) is first isolated from the plasticizer.

When we say that the stiff poly(vinyl butyral) is separated from the poly(vinyl butyral) mixture by decanting or sedimentation, we mean that the liquid is separated from the stiff poly(vinyl butyral) solids, for example, by letting the solids settle to the bottom of the vessel, and removing the bulk of the additional plasticizer from the granulates.

When we say that the stiff poly(vinyl butyral) is separated by filtering, we mean that the stiff poly(vinyl butyral) solids of the granulates are filtered from the plasticizer.

When we say that the stiff poly(vinyl butyral) is separated from the mixture by centrifuging, we mean that the solids are separated from the liquid using a centrifuge.

The invention may be further understood according to the following further description.

Thus, in one aspect, the multilayered poly(vinyl butyral) sheets of the invention may comprise interlayers comprising one or more stiff skin layers and a soft core layer(s). In an embodiment, these multilayered interlayer sheets may comprise: a first polymer layer (skin layer) comprising a stiff plasticized poly(vinyl butyral) resin; a second polymer layer (core layer) comprising a soft plasticized poly(vinyl butyral) resin, or a blend thereof having the same or different residual hydroxyl content; and optionally a third polymer layer (skin layer) comprising stiff plasticized poly(vinyl butyral) resin. The second or core polymer layer is disposed adjacent the first polymer layer. If there are three or more layers, the second polymer layer may be disposed between the first polymer layer and the third polymer layer, resulting in two skin layers and a central core layer.

In embodiments, the second or core poly(vinyl butyral) resin may be present in an amount of from about 2 weight percent to about 45 weight percent, or from about 5 weight percent to about 40 weight percent.

Plasticizers work by embedding themselves between chains of polymers, spacing them apart (increasing the “free volume”) and thus significantly lowering the glass transition temperature (Tg) of the polymer resin (typically by 0.5 to 4 degrees C./phr), making the material softer. In this regard, the amount of plasticizer in the interlayer can be adjusted to affect the glass transition temperature (Tg). The glass transition temperature (Tg) is the temperature that marks the transition from the glassy state of the interlayer to the rubbery state. In general, higher amounts of plasticizer loading will result in lower Tg. Conventional interlayers generally have had a Tg in the range of about 0° C. for acoustic (noise reducing) interlayers to about 45° C. for hurricane and aircraft interlayer applications.

An interlayer's glass transition temperature is also correlated with the stiffness of the interlayer—the higher the glass transition temperature, the stiffer the interlayer. Generally, an interlayer with a glass transition temperature of about 30° C. or higher increases windshield strength and torsional rigidity. A soft interlayer (generally characterized by an interlayer with a glass transition temperature of lower than about 30° C.), on the other hand, contributes to the sound dampening effect (i.e., the acoustic characteristics). The multilayered interlayers of the present disclosure combine these two advantageous properties (i.e., strength and acoustic) by utilizing harder or stiffer skin layers laminated with a softer core layer (e.g., stiff//soft//stiff), with the skin layers having increased flow at autoclave temperatures. In various embodiments, the multilayered interlayers generally comprise skin layers with a glass transition temperature of about 30° C. to about 55° C. and core layer(s) with a glass transition temperature of about 0° C. to about 10° C.

In embodiments, the plasticizers used herein may be selected from dipropylene glycol dibenzoate, tripropylene glycol dibenzoate, polypropylene glycol dibenzoate, isodecyl benzoate, 2-ethylhexyl benzoate, diethylene glycol benzoate, butoxyethyl benzoate, butoxyethyoxyethyl benzoate, butoxyethoxyethoxyethyl benzoate, propylene glycol dibenzoate, 2,2,4-trimethyl-1,3-pentanediol dibenzoate, 2,2,4-trimethyl-1,3-pentanediol benzoate isobutyrate, 1,3-butanediol dibenzoate, diethylene glycol di-o-toluate, triethylene glycol di-o-toluate, dipropylene glycol di-o-toluate, 1,2-octyl dibenzoate, tri-2-ethylhexyl trimellitate, di-2-ethylhexyl terephthalate, bis-phenol A bis(2-ethylhexaonate), di-(butoxyethyl) terephthalate, di-(butoxyethyoxyethyl) terephthalate, and mixtures thereof, or as described elsewhere herein. In embodiments, the plasticizer may be a mix of two or more plasticizers. In embodiments, the interlayer may further comprise a second high refractive index plasticizer having a refractive index of at least 1.460. In other embodiments, the interlayer may further comprise a plasticizer having a refractive index of less than about 1.450.

In embodiments, the percent haze may be less than 0.5% (as measured by ASTM D1003-61 (Re-approved 1977)-Procedure A using Illuminant C, at an observer angle of 2 degrees).

In embodiments, the residual hydroxyl content of the third or stiff poly(vinyl butyral resin) is typically the same as the residual hydroxyl content of the first stiff poly(vinyl butyral resin) and typically differs from that in the second or core poly(vinyl butyral resin). In embodiments, the difference between the core residual hydroxyl content and the skin residual hydroxyl content is at least 4.0 weight percent, or at least 6.0 weight percent.

In embodiments, the second poly(vinyl butyral) resin is present in an amount of from about 2 weight percent to about 45 weight percent, or from about 5 weight percent to about 40 weight percent.

In embodiments, the polymer interlayer has at least two different glass transition temperatures (T g) and the difference between at least two different glass transition temperatures (T g) is at least 5° C.

In embodiments, the residual hydroxyl content of the third, or skin, poly(vinyl butyral resin) is the same as the residual hydroxyl content of the first, or core, poly(vinyl butyral) resin.

A multiple layer panel is also disclosed. The multiple layer panel comprises at least one rigid substrate, and a polymer interlayer or multiple layer polymer interlayer as disclosed herein. The panel has improved optical properties.

In one aspect of the invention, a single plasticizer such as triethylene glycol bis(2-ethylhexanoate) may be used, or mixtures of this with dihexyladipate.

The invention thus relates to a method of using plasticizer as an extractant to preferentially remove, wash, or partially dissolve the soft poly(vinyl butyral) resin from the poly(vinyl butyral) granulate by taking advantage of solubility differences of the PVB components in the plasticizer. This is distinguished from the use of traditional solvents. The present invention therefore affords a way of reclaiming raw material for reintroduction into the manufacturing processes, optionally without first isolating the soft poly(vinyl butyral) resin from the plasticizer.

Because of the difference in the cloud points of the PVB resin of different compositions, specifically, as measured by residual % PVOH, in the plasticizer, the technique allows the use of temperature as a key parameter for effective separation of different PVB components. In this respect, the additional plasticizer may be added to the poly(vinyl butyral) granulate at a temperature of at least 25°, or at least 30° C., or from about 25° C. to about 90° C., or 30° C. to about 60° C., or as disclosed elsewhere herein.

The invention also describes a method of removing extracted PVB resin from the plasticizer extracts to enable the repeated use of plasticizer in the recycling operations.

This invention thus describes a method of removing extracted poly(vinyl butyral) from the plasticizer to enable the repeated use of solvent in the extraction. Poly(vinyl butyral) compounds that are isolated from a multi-layer poly(vinyl butyral) sheet with acceptable purity for re-use, are in this invention the result of a process that includes a step described as fractionation, extraction or selective dissolution. In this context, fractionation, extraction or selective dissolution means that primarily the soft poly(vinyl butyral) is removed or washed from the poly(vinyl butyral) granulate, while the stiff poly(vinyl butyral) resin remains primarily in the poly(vinyl butyral) granulate as a solid in the solvent, possibly in a swollen state.

The poly(vinyl butyral) compounds are components of a multi-layer poly(vinyl butyral) sheet, where each layer is composed of a poly(vinyl butyral) and a plasticizer with different compositions in terms of the poly(vinyl butyral) composition, i.e. a different residual hydroxyl or residual acetate content, and plasticizer content. Mostly, the amount of plasticizer relative to the amount of poly(vinyl butyral) is different. Significant extraction of a poly(vinyl butyral) compound from a multi-layer sheet granulate is typically obtained after grinding the off grade sheet to smaller flakes, generally to a size ranging from 3 to 30 mm.

The degree of separation is depending on the applied plasticizer, e.g. the extraction of core layer PVB from a poly(vinyl butyral) multi-layer sheet using triethylene glycol bis(2-ethylhexanoate) proceeds to an extent that 25 to 50% of core layer PVB is removed in a single fractionation step. Repeating the extraction will increase the extent of separation between the different poly(vinyl butyral) compounds. Typically, extraction is obtained when multi-layer sheet or parts thereof are exposed to a specific solvent in a temperature range between 25 and 100° C., with extraction times between 5 mins and several days for one extraction cycle.

Conventional multilayer interlayers such as a trilayer acoustic interlayer typically contain a soft core layer consisting of a single poly(vinyl butyral) (“PVB”) resin having a low residual hydroxyl content and a high amount of a conventional plasticizer, and two stiff skin layers having significantly higher residual hydroxyl content (see, for example U.S. Pat. Nos. 5,340,654, 5,190,826, and 7,510,771). Thus, the isolated soft poly(vinyl butyral) may be recycled to form the core layer of a trilayer acoustic interlayer, or the soft poly(vinyl butyral) and plasticizer varnish may be used directly to form a soft poly(vinyl butyral) layer without first separating the two. The residual hydroxyl content in the PVB core resin and the amount of the plasticizer are optimized such that the interlayer provides optimal sound insulation property under ambient conditions for multiple layer glass panels such as windshields and windows installed on vehicles and buildings.

The terms “polymer interlayer sheet,” “interlayer,” and “polymer melt sheet” as used herein, generally may designate a single-layer sheet or a multilayered interlayer. A “single-layer sheet,” as the name implies, is a single polymer layer extruded as one layer. A multilayered interlayer sheet, on the other hand, may comprise multiple layers, including separately extruded layers, co-extruded layers, or any combination of separately and co-extruded layers. Thus the multilayered interlayer sheet could comprise, for example: two or more single-layer sheets combined together (“plural-layer sheet”); two or more layers co-extruded together (“co-extruded sheet”); two or more co-extruded sheets combined together; a combination of at least one single-layer sheet and at least one co-extruded sheet; a combination of a single-layer sheet and a plural-layer sheet; and a combination of at least one plural-layer sheet and at least one co-extruded sheet. In various embodiments of the present disclosure, a multilayered interlayer sheet comprises at least two polymer layers (e.g., a single layer or multiple layers co-extruded and/or laminated together) disposed in direct contact with each other, wherein each layer comprises a polymer resin, as detailed more fully below. As used herein for multilayer interlayers having at least three layers, “skin layer” generally refers to the outer layers of the interlayer and “core layer” generally refers to the inner layer(s). Thus, one exemplary embodiment would be: skin layer//core layer//skin layer.

The PVB resin is produced by known acetalization processes by reacting polyvinyl alcohol (“PVOH”) with butyraldehyde in the presence of an acid catalyst, separation, stabilization, and drying of the resin. Such acetalization processes are disclosed, for example, in U.S. Pat. Nos. 2,282,057 and 2,282,026 and Vinyl Acetal Polymers, in Encyclopedia of Polymer Science & Technology, 3rd edition, Volume 8, pages 381-399, by B. E. Wade (2003), the entire disclosures of which are incorporated herein by reference. The resin is commercially available in various forms, for example, as Butvar® Resin from Solutia Inc., a wholly owned subsidiary of Eastman Chemical Company.

As used herein, residual hydroxyl content (calculated as % vinyl alcohol or % PVOH by weight) in PVB refers to the amount of hydroxyl groups remaining on the polymer chains after processing is complete. For example, PVB can be manufactured by hydrolyzing poly(vinyl acetate) to poly(vinyl alcohol (PVOH), and then reacting the PVOH with butyraldehyde. In the process of hydrolyzing the poly(vinyl acetate), typically not all of the acetate side groups are converted to hydroxyl groups. Further, reaction with butyraldehyde typically will not result in all hydroxyl groups being converted to acetal groups. Consequently, in any finished PVB resin, there typically will be residual acetate groups (as vinyl acetate groups) and residual hydroxyl groups (as vinyl hydroxyl groups) as side groups on the polymer chain. As used herein, residual hydroxyl content and residual acetate content is measured on a weight percent (wt. %) basis per ASTM D1396.

The PVB resins of the present disclosure typically have a molecular weight of greater than 50,000 Daltons, or less than 500,000 Daltons, or about 50,000 to about 500,000 Daltons, or about 70,000 to about 500,000 Daltons, or about 100,000 to about 425,000 Daltons, as measured by size exclusion chromatography using low angle laser light scattering. As used herein, the term “molecular weight” means the weight average molecular weight.

Various adhesion control agents (“ACAs”) can be used in the interlayers of the present disclosure to control the adhesion of the interlayer sheet to glass. In various embodiments of interlayers of the present disclosure, the interlayer can comprise about 0.003 to about 0.15 parts ACAs per 100 parts resin; about 0.01 to about 0.10 parts ACAs per 100 parts resin; and about 0.01 to about 0.04 parts ACAs per 100 parts resin. Such ACAs, include, but are not limited to, the ACAs disclosed in U.S. Pat. No. 5,728,472 (the entire disclosure of which is incorporated herein by reference), residual sodium acetate, potassium acetate, magnesium bis(2-ethyl butyrate), and/or magnesium bis(2-ethylhexanoate).

Other additives may be incorporated into the interlayer to enhance its performance in a final product and impart certain additional properties to the interlayer. Such additives include, but are not limited to, dyes, pigments, stabilizers (e.g., ultraviolet stabilizers), antioxidants, anti-blocking agents, flame retardants, IR absorbers or blockers (e.g., indium tin oxide, antimony tin oxide, lanthanum hexaboride (LaB₆) and cesium tungsten oxide), processing aides, flow enhancing additives, lubricants, impact modifiers, nucleating agents, thermal stabilizers, UV absorbers, dispersants, surfactants, chelating agents, coupling agents, adhesives, primers, reinforcement additives, and fillers, among other additives known to those of ordinary skill in the art.

The plasticizers or mixture of plasticizers in the skin and core layers are selected such that the multilayer acoustic interlayer exhibits acceptable levels of haze and visual transmittance. In various embodiments, the plasticizer is selected from high refractive index plasticizers, a mixture of two or more high refractive index plasticizers, or a mixture of conventional and high refractive index plasticizers. In various embodiments, the high refractive index plasticizer(s) is selected to eliminate potential high haze arising from blending two or more resins of different residual hydroxyl content. In various embodiments of the present disclosure, haze is less than 5%, less than 3%, and less than 1%, less than 0.3%.

As used herein, plasticizer having a refractive index of about 1.450 or less is referred to as a “conventional plasticizer”. Conventional plasticizers include, but are not limited to, triethylene glycol bis(2-ethylhexanoate) (“3-GEH”), triethylene glycol bis(2-ethylbutyrate), triethylene glycol diheptanoate, tetraethylene glycol diheptanoate, tetraethylene glycol bis(2-ethylhexanoate), dihexyl adipate, dioctyl adipate, hexyl cyclohexyladipate, diisononyl adipate, heptylnonyl adipate, di(butoxyethyl) adipate, bis(2-butoxyethyl)adipate and bis(2-(2-butoxyethoxy)ethyl) adipate, dibutyl sebacate, dioctyl sebacate, and mixtures thereof. These plasticizers have refractive indices of about 1.442 to about 1.449. In comparison, PVB resin has a refractive index of approximately 1.485 to 1.495. 3-GEH (refractive index=1.442) is the most common plasticizer present in interlayers manufactured for various properties and applications.

In various embodiments, the high refractive index plasticizer(s) is selected such that the refractive index of the plasticizer is at least about 1.460, or greater than about 1.460, or greater than about 1.470, or greater than about 1.480, or greater than about 1.490, or greater than about 1.500, or greater than 1.510, or greater than 1.520, for both the core and skin layers. As used herein, a “high refractive index plasticizer” is a plasticizer having a refractive index of at least about 1.460. In some embodiments, the high refractive index plasticizer(s) is used in conjunction with a conventional plasticizer, and in some embodiments, if included, the conventional plasticizer is triethylene glycol di-(2-ethylhexanoate) (“3-GEH”), and the refractive index of the plasticizer mixture is at least 1.460. As used herein, the refractive index (also known as index of refraction) of a plasticizer or a resin used in the entirety of this disclosure is either measured in accordance with ASTM D542 at a wavelength of 589 nm and 25° C. or reported in literature in accordance with the ASTM D542.

Examples of plasticizers having a high refractive index that may be used include, but are not limited to, polyadipates (RI of about 1.460 to about 1.485); epoxides (RI of about 1.460 to about 1.480); phthalates and terephthalates (RI of about 1.480 to about 1.540); benzoates (RI of about 1.480 to about 1.550); and other specialty plasticizers (RI of about 1.490 to about 1.520). Examples of high refractive index plasticizers include, but are not limited to, esters of a polybasic acid or a polyhydric alcohol, polyadipates, epoxides, phthalates, terephthalates, benzoates, toluates, mellitates and other specialty plasticizers, among others. Examples of suitable high refractive index plasticizers include, but are not limited to, dipropylene glycol dibenzoate, tripropylene glycol dibenzoate, polypropylene glycol dibenzoate, isodecyl benzoate, 2-ethylhexyl benzoate, diethylene glycol benzoate, propylene glycol dibenzoate, 2,2,4-trimethyl-1,3-pentanediol dibenzoate, 2,2,4-trimethyl-1,3-pentanediol benzoate isobutyrate, 1,3-butanediol dibenzoate, diethylene glycol di-o-toluate, triethylene glycol di-o-toluate, dipropylene glycol di-o-toluate, 1,2-octyl dibenzoate, tri-2-ethylhexyl trimellitate, di-2-ethylhexyl terephthalate, bis-phenol A bis(2-ethylhexaonate), ethoxylated nonylphenol, and mixtures thereof.

In various embodiments of interlayers of the present disclosure, the interlayer comprises greater than 5 phr, about 5 to about 120 phr, about 10 to about 90 phr, about 20 to about 70 phr, about 30 to about 60 phr, or less than 120 phr, or less than 90 phr, or less than 60 phr, or less than 40 phr, or less than 30 phr total plasticizer. While the total plasticizer content is indicated above, the plasticizer content in the skin layer(s) or core layer(s) can be different from the total plasticizer content. In addition, the skin layer(s) and core layer(s) can have different plasticizer types and plasticizer contents, in the ranges previously discussed, as each respective layer's plasticizer content at the equilibrium state is determined by the layer's respective residual hydroxyl contents, as disclosed in U.S. Pat. No. 7,510,771 (the entire disclosure of which is incorporated herein by reference). For example, at equilibrium the interlayer could comprise two skin layers, each with 30 phr plasticizer, and a core layer with 65 phr plasticizer, for a total plasticizer amount for the interlayer of about 45.4 phr when the combined skin layer thickness equals that of the core layer. For thicker or thinner skin layers, the total plasticizer amount for the interlayer would change accordingly. In various embodiments of the present invention, the plasticizer content of the core layer and skin layer differs by at least 8 phr, or at least 9 phr, or at least 10 phr, or at least 12 phr, or at least 13 phr, or at least 14 phr, or at least 15 phr, or at least 16 phr, or at least 17 phr, or at least 18 phr, or at least 19 phr, or at least 20 phr, or at least 25 phr or more. As used herein, the amount of plasticizer, or any other component in the interlayer, can be measured as parts per hundred parts resin (phr), on a weight per weight basis. For example, if 30 grams of plasticizer is added to 100 grams of polymer resin, then the plasticizer content of the resulting plasticized polymer would be 30 phr. As used herein, when the plasticizer content of the interlayer is given, the plasticizer content is determined with reference to the phr of the plasticizer in the mix or melt that was used to produce the interlayer.

The final interlayer, whether formed from extrusion or co-extrusion, generally has a random rough surface topography as it is formed through melt fractures of polymer melt as it exits the extrusion die and may additionally be embossed over the random rough surface on one or both sides (e.g., the skin layers) by any method of embossment known to one of ordinary skill in the art.

While all methods for the production of polymer interlayer sheets known to one of ordinary skill in the art are contemplated as possible methods for producing the polymer interlayer sheets described herein, this application will focus on polymer interlayer sheets produced through the extrusion and co-extrusion processes. The final multiple layer glass panel laminate of the present invention are formed using lamination processes known in the art.

Generally, the thickness, or gauge, of the polymer interlayer sheet will be in a range from about 15 mils to 100 mils (about 0.38 mm to about 2.54 mm), about 15 mils to 60 mils (about 0.38 mm to about 1.52 mm), about 20 mils to about 50 mils (about 0.51 to 1.27 mm), and about 15 mils to about 35 mils (about 0.38 to about 0.89 mm). In various embodiments, each of the layers, such as the skin and core layers, of the multilayer interlayer may have a thickness of about 1 mil to 99 mils (about 0.025 to 2.51 mm), about 1 mil to 59 mils (about 0.025 to 1.50 mm), 1 mil to about 29 mils (about 0.025 to 0.74 mm), or about 2 mils to about 28 mils (about 0.05 to 0.71 mm).

Although the embodiments described below refer to the polymer resin as being poly(vinyl butyral) PVB, it would be understood by one of ordinary skill in the art that the polymer may be any polymer suitable for use in a multiple layer panel. Typical polymers include, but are not limited to, polyvinyl acetals (PVA) (such as PVB or isomeric poly(vinyl isobutyral) (PVisoB), polyurethane (PU), poly(ethylene-co-vinyl acetate) (EVA), polyvinylchloride (PVC), poly(vinylchloride-co-methacrylate), polyethylenes, polyolefins, ethylene acrylate ester copolymers, poly(ethylene-co-butyl acrylate), silicone elastomers, epoxy resins, and acid copolymers such as ethylene/carboxylic acid copolymers and its ionomers, derived from any of the foregoing possible thermoplastic resins, combinations of the foregoing, and the like. PVB and its isomeric polymer PVisoB, polyvinyl chloride, and polyurethane are particularly useful polymers generally for interlayers; PVB (and its isomeric polymer) is particularly preferred. For example, the multilayered interlayer can consist of PVB//PVisoB//PVB. Other examples include PVB//PVC//PVB or PVB//PU//PVB. Further examples include PVC//PVB//PVC or PU//PVB//PU.

As used herein, a multiple layer panel can comprise a single substrate, such as glass, acrylic, or polycarbonate with a polymer interlayer sheet disposed thereon, and most commonly, with a polymer film further disposed over the polymer interlayer. The combination of polymer interlayer sheet and polymer film is commonly referred to in the art as a bilayer. A typical multiple layer panel with a bilayer construct is: (glass)//(polymer interlayer sheet)//(polymer film), where the polymer interlayer sheet can comprise multiple interlayers, as noted above. The polymer film supplies a smooth, thin, rigid substrate that affords better optical character than that usually obtained with a polymer interlayer sheet alone and functions as a performance enhancing layer. Polymer films differ from polymer interlayer sheets, as used herein, in that polymer films do not themselves provide the necessary penetration resistance and glass retention properties, but rather provide performance improvements, such as infrared absorption characteristics. Poly(ethylene terephthalate) (“PET”) is the most commonly used polymer film. Generally, as used herein, a polymer film is thinner than a polymer sheet, such as from about 0.001 to 0.2 mm thick.

The interlayers of the present disclosure will most commonly be utilized in multiple layer panels comprising two substrates, such as a pair of glass sheets (or other rigid materials, such as polycarbonate or acrylic, known in the art), with the interlayers disposed between the two substrates. An example of such a construct would be: (glass)//(polymer interlayer sheet)//10 (glass), where the polymer interlayer sheet can comprise multilayered interlayers, as noted above. These examples of multiple layer panels are in no way meant to be limiting, as one of ordinary skill in the art would readily recognize that numerous constructs other than those described above could be made with the interlayers of the present disclosure.

The typical glass lamination process comprises the following steps: (1) assembly of the two substrates (e.g., glass) and interlayer; (2) heating the assembly via an IR radiant or convective means for a short period; (3) passing the assembly into a pressure nip roll for the first deairing; (4) heating the assembly a second time to about 60° C. to about 120° C. to give the assembly enough temporary adhesion to seal the edge of the interlayer; (5) passing the assembly into a second pressure nip roll to further seal the edge of the interlayer and allow further handling; and (6) autoclaving the assembly at temperatures between 135° C. and 150° C. and pressures between 180 psig and 200 psig for about 30 to 90 minutes. The actual steps, as well as the times and temperatures, may vary as necessary, as known by one skilled in the art.

Other means for use in de-airing of the interlayer-glass interfaces (steps 2-5) known in the art and that are commercially practiced include vacuum bag and vacuum ring processes in which a vacuum is utilized to remove the air.

As previously indicated, clarity is a parameter used to describe the polymer interlayers disclosed herein. Clarity is determined by measuring the haze value or percent haze. The test for percent haze is performed with a hazemeter, such as Model D25 available from Hunter Associates (Reston, VA), and in accordance with ASTM D1003-61 (Re-approved 1977)-Procedure A using Illuminant C, at an observer angle of 2 degrees. The polymer interlayers are laminated with a pair of clear glass sheets each of 2.3 mm thick (commercially available from Pittsburgh Glass Works of Pennsylvania) and the haze values are measured. The interlayers of the present disclosure have a percent haze of less than about 5%, less than about 4%, less than about 3%, less than about 2%, less than about 1%, or less than about 0.3%.

Transparency, or percent visual transmittance (% Tᵥᵢₛ) is also used to describe the polymer interlayers disclosed herein. The transparency is also measured with a hazemeter, such as Model D25 available from Hunter Associates (Reston, VA), and in Illuminant D65, at an observer angle of 10 degrees. The polymer interlayers are laminated with a pair of clear glass sheets each of 2.3 mm thick (commercially available from Pittsburgh Glass Works of Pennsylvania) and the % Tᵥᵢₛ is measured. The polymer interlayers of the present disclosure have a % Tᵥᵢₛ of greater than 85 for the interlayers containing only additives of ACAs, UV stabilizers, and antioxidant, or greater than 80% for the interlayers containing additional additives such as pigments, IR absorbers or blockers as mentioned above. Polymer interlayers containing high levels of pigments and/or dyes may have lower % Tᵥᵢₛ values as desired, such as in mass pigmented or colored polymer interlayers.

The refractive index (RI) was measured in accordance with ASTM D542. The reported RI values were obtained at a wavelength of 589 nm and at 25° C.

The glass transition temperature (T g) may be determined by dynamical mechanical thermal analysis (DMTA). The DMTA measures the storage (elastic) modulus (G′) in Pascals, loss (viscous) modulus (G″) in Pascals, tan delta (=G″/G′) of the specimen as a function of temperature at a given frequency, and temperature sweep rate. A frequency of 1 Hz and temperature sweep rate of 3° C./min were used herein. The T g is then determined by the position of the tan delta peak on the temperature scale in ° C.

The damping loss factor (n) may be measured by Mechanical Impedance Measurement as described in ISO 16940. A laminated glass bar sample of 25 mm wide, 300 mm long, and having a pair of 2.3 mm clear glass is prepared and excited at the center point of the bar by a vibration shaker (Brüel and Kjær). An impedance head (Brüel and Kjær) is used to measure the force to excite the bar to vibrate and the velocity of the vibration and the resultant transfer function is recorded on a National Instrument data acquisition and analysis system. The loss factor at the first vibration mode is calculated using the half-power method.

“Sound transmission loss” (STL) is determined for a laminate of fixed dimensions with ASTM E90 (2009) at a fixed temperature of 20° C. A “Reference Panel” of 2.3 mm clear glass//“Reference interlayer”//2.3 mm clear glass is measured to have a coincident frequency at 3,150 Hz and STL of 31 dB at the coincident frequency, wherein the “Reference Interlayer” is produced by mixing and melt-extruding 100 parts poly(vinyl butyral) resin having a residual hydroxyl content of 18 to 19 wt. % and a vinyl acetate residue of 2 wt. %, 38 parts by weight of 3-GEH plasticizer, and other common additives (as described above). The reference interlayer has a thickness of 0.76 mm a glass transition temperature of 30° C. The multilayer interlayers of the present invention or the comparative multilayer interlayers are laminated with 2.3 mm clear glass according to the method described above for making the reference (or test) laminated glass panel. The panel has a dimension of 50 cm by 80 cm. The STL of the test panel at the coincident frequency of the “Reference Panel”, e.g., STL at 3,150 Hz, is used to assess the sound insulation property of the panel.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, each numerical parameter should at least be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10.

Notwithstanding that the numerical ranges and parameters setting forth the broad scope of the invention are approximations, the numerical values set forth in the specific examples are intended to be reported precisely in view of methods of measurement. Any numerical value, however, inherently contains certain errors necessarily resulting from the standard deviation found in their respective testing measurements.

It is to be understood that the mention of one or more process steps does not preclude the presence of additional process steps before or after the combined recited steps or intervening process steps between those steps expressly identified. Moreover, the denomination of process steps, ingredients, or other aspects of the information disclosed or claimed in the application with letters, numbers, or the like is a convenient means for identifying discrete activities or ingredients and the recited lettering can be arranged in any sequence, unless otherwise indicated.

As used herein, the singular forms “a”, “an”, and “the” include plural referents unless the context clearly dictates otherwise. For example, reference to a Cₙ alcohol equivalent is intended to include multiple types of Cₙ alcohol equivalents. Thus, even use of language such as “at least one” or “at least some” in one location is not intended to imply that other uses of “a”, “an”, and “the” excludes plural referents unless the context clearly dictates otherwise. Similarly, use of the language such as “at least some” in one location is not intended to imply that the absence of such language in other places implies that “all” is intended, unless the context clearly dictates otherwise.

As used herein the term “and/or”, when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

This invention can be further illustrated by the following examples of embodiments thereof, although it will be understood that these examples are included merely for purposes of illustration and are not intended to limit the scope of the invention unless otherwise specifically indicated.

### EXAMPLES

### Example 1

Multi-layer sheet samples were cut into approximately 15 mm pieces. 300 g of multi-layer chips and 700 g of triethylene glycol bis(2-ethylhexanoate) (3-GEH) were charged to a 1 L glass reactor with agitator. The mixture was agitated and heated to 80° C. and held for 2 hours. The resulting batch was cooled to room temperature and filtered with a Buchner funnel with 1 mm openings. To 500 g of filtrate 5 g of water was added and stirred for one hour and the mixture was allowed to settle for overnight before centrifugation. After centrifugation, 455 g of clear 3-GEH centrates and 45 g of sediment material (water and core layer PVB) were obtained.

### Example 2

Multi-layer sheet samples were cut into approximately half inch pieces. 300 g of multi-layer chips, 245 g of 3-GEH and 455 g of centrates from example 1 were charged to a 1 L glass reactor. The mixture was agitated and heated to 70° C. and held for 4 hours. The resulting batch was cooled to room temperature and filtered with a Buchner funnel (with 1 mm openings). To 500 g filtrates were added 5 g of water containing 1% KOAC and stirred for one hour. The mixture was allowed to settle overnight before centrifugation. After centrifugation, 480 g of clear 3-GEH centrates and 20 g of sediment material (water and PVB compound with composition 2) were obtained.

### Example 3

300 g of multi-layer chips, 245 g of 3-GEH and 455 g of centrates from the above example were charged to a 1 L glass reactor. The mixture was agitated and heated to 70° C. and held for 4 hours. The resulting batch was cooled to 5° C. and filtered with a Buchner funnel (with 1 mm openings). The 524 g filtrates were added 5 g of water and stirred for 10 min and the mixture was allowed to settle for overnight before centrifugation. After centrifugation, 480 g of clear 3-GEH centrates and 20 g of sediment material (water and PVB with composition 2) were obtained.

TABLE 1
Ratio of PVB compounds in fractions from examples
1 to 3, as collected by chromatography.

| Sample | PVB 1 | PVB 2 |
|---|---|---|
| Original multi-layer chips | 82.7 | 17.3 |
| chips after 95° C. 2 h | 94.7 | 5.3 |
| 3-GEH extract, 95° C. 2 h | 53.2 | 46.8 |
| chips after 65° C. 4 h | 91 | 9 |
| 3-GEH extract after 65° C. 4 h | 16.4 | 83.6 |
| chips after 80° C. 1 × 2 h | 90.7 | 9.3 |
| chips 80° C. 2 × 1 h | 93.5 | 6.5 |
| chips after 80° C. 3 × 1 h | 97.5 | 2.5 |
| 3-GEH extract 80° C. 3 × 1 h | 12.5 | 87.5 |
| chips after 80° C. 2 h | 90.8 | 9.2 |
| 3-GEH extract after 80° C. 2 h | 15.5 | 84.5 |

Examples 1 to 3 describe treatments applied to samples of granulated multilayer sheet, obtained after grinding and passing through a 12 mm screen. The multilayer sheet total thickness was 0.84 mm, core layer thickness was 0.11 mm. Overall plasticizer content was 42.1, skin layer plasticizer was 38, core layer plasticizer was 75. The skin layer PVB had a hydroxyl content of 19% and acetate content of about 1.5%. The core layer PVB had a hydroxyl content of 11% and acetate content of about 1%.

### Example 4

Multi-layer sheet samples were cut into pieces with at least one dimension <6 mm. 250 g of multi-layer chips and 750 g of triethylene glycol bis(2-ethylhexanoate) (3-GEH) were charged to a 2 L setup with agitator. The liquid was agitated to 65° C. before addition of the solids, after addition it was kept stirring for 2 hours at 55° C. The slurry batch was transferred to a buchner funnel with 1 mm openings for solid-liquid separation. To 664 g of filtrate, 33 g of a 25% potassium Acetate solution in water was added and stirred before cooling and centrifugation. After centrifugation, 3-GEH centrates were obtained as the liquid phase, the obtained sediment material was a mixture of water, 3-GEH and core layer PVB. The varnish sediment material was heated to T˜130° C. at atmospheric pressure in a jacketed and stirred stainless steel tank. It was held for 24 hours until the temperature further increased (indicating all water was removed), after which the mixture was allowed to cool down to obtain the varnish.

### Example 5

Varnish Recycled into Product 1

16.1 pound of varnish was blended with about 87.6 pounds of virgin PVB resin, 6.2 pound of multi-layer PVB flakes, 20.5 pound of triethylene glycol bis(2-ethylhexanoate). The whole mixture was compounded in a batch mixer before being discharged into an extruder for PVB sheet extrusion.

### Example 6

Varnish Recycled into Product 2:

16.1 pounds of varnish was blended with 87.6 pounds of PVB resin, 12.7 pound of multi-layer PVB flakes, 3.2 pounds of calcium carbonate, 20.5 pounds of triethylene glycol bis(2-ethylhexanoate). The whole mixture was compounded in a batch mixer before being discharged into an extruder for PVB sheet extrusion.

### Example 7

Varnish Recycled into Product 3:

15.0 pounds of varnish was blended with 100 pounds of PVB core resin, 60 pounds of triethylene glycol bis(2-ethylhexanoate). The whole mixture was compounded in a batch mixer before being discharged into an extruder for PVB sheet co-extrusion to make a multi-layer PVB product.

TABLE 2
Fit-for-use data for Product 1 and Product 2 measured in a laminate

| | Transmission | Yellowness | Haze | Peel Adhesion |
|---|---|---|---|---|
| | (%) | Index | (%) | (N/cm) |
| Reference for | 88.71 | −0.38 | 0.24 | 50.2 |
| Product 1 | | | | |
| Product 1 | 88.33 | 0.16 | 0.30 | 28 |
| Reference for | 64.00 | 5.36 | N.A. | 56.7 |
| Product 2 | | | | |
| Product 2 | 64.15 | 6.34 | N.A. | 46.3 |
| Reference for | 88.96 | −0.18 | 0.19 | 31.3 |
| Product 3 | | | | |
| Product 3 | 89.20 | −0.36 | 0.31 | 32.6 |

1. A process for recovering stiff poly(vinyl butyral) from a plasticized poly(vinyl butyral) multilayer sheet containing the stiff poly(vinyl butyral) and soft poly(vinyl butyral), the process comprising:
a. grinding the plasticized poly(vinyl butyral) multilayer sheet to obtain a poly(vinyl butyral) granulate;
b. adding additional plasticizer to the poly(vinyl butyral) granulate to remove at least a portion of the soft poly(vinyl butyral) from the poly(vinyl butyral) granulate to obtain a granulate enriched in the stiff poly(vinyl butyral) and a varnish of the soft poly(vinyl butyral) and the additional plasticizer; and
c. physically separating the granulate enriched in the stiff poly(vinyl butyral) from the varnish of the soft poly(vinyl butyral) and the additional plasticizer.

2. The process of claim 1, wherein the step of physically separating the granulate is carried out using one or more techniques selected from decanting, filtering, or centrifuging.

3. The process of claim 1, wherein the removing of at least a portion of the soft poly(vinyl butyral) from the poly(vinyl butyral) granulate comprises selectively washing away the soft poly(vinyl butyral) from the poly(vinyl butyral) granulate.

4. The process of claim 1, further comprising:
d. adding further additional plasticizer to the granulate enriched in the stiff poly(vinyl butyral) to remove an additional portion of the soft poly(vinyl butyral) from the granulate;
e. separating the granulate from the additional portion of the soft poly(vinyl butyral) and the further additional plasticizer using one or more techniques selected from decanting, filtering, or centrifuging.

5. The process of claim 1, wherein the additional plasticizer is selected from one or more of esters of a polybasic acid or a polyhydric alcohol.

6. The process of claim 1, wherein the additional plasticizer is added to the poly(vinyl butyral) granulate at a temperature from about 25° C. to about 90° C.

7. The process of claim 1, wherein the additional plasticizer is selected from one or more of: triethylene glycol bis(2-ethylhexanoate), tetraethylene glycol bis(2-ethylhexanoate), triethylene glycol bis(2-ethylbutyrate), triethylene glycol diheptanoate, tetraethylene glycol diheptanoate, dihexyl adipate, bis(2-ethylhexyl)adipate, bis(2-ethoxyethyl)adipate, dioctyl adipate, hexyl cyclohexyladipate, diisononyl adipate, heptylnonyl adipate, dibutyl sebacate, polymeric adipates, a soybean oil, or an epoxidized soybean oil.

8. The process of claim 1, wherein the soft poly(vinyl butyral) has a residual hydroxyl content from about 8% to about 12%.

9. The process of claim 1, wherein the stiff poly(vinyl butyral) has a residual hydroxyl content of from about 15% to about 25%.

10. The process of claim 1, wherein the soft poly(vinyl butyral) has a residual acetate content less than about 15%.

11. The process of claim 1, wherein the stiff poly(vinyl butyral) has a residual acetate content of less than about 5%.

12. The process of claim 1, wherein the soft poly(vinyl butyral) contained in the plasticized poly(vinyl butyral) multilayer sheet comprises triethylene glycol bis(2-ethylhexanoate) present as a plasticizer.

13. The process of claim 1, wherein the soft poly(vinyl butyral) contained in the plasticized poly(vinyl butyral) multilayer sheet further comprises dihexyladipate present as a plasticizer.

14. The process of claim 1, wherein the triethylene glycol bis(2-ethylhexanoate) is present in the soft poly(vinyl butyral) in an amount from about 60 phr to about 100 phr.

15. The process of claim 1, wherein the additional plasticizer added to the poly(vinyl butyral) granulate in step b) comprises triethylene glycol bis(2-ethylhexanoate).

16. The process of claim 1, wherein the difference between the residual hydroxyl content of the soft poly(vinyl butyral) and the residual hydroxyl content of the stiff poly(vinyl butyral) is at least 4.0 weight percent.

17. The process of claim 1, wherein the stiff poly(vinyl butyral) contained in the plasticized poly(vinyl butyral) multilayer sheet comprises from about 30 phr to about 45 phr plasticizer.

18. The process of claim 1, further comprising subjecting the varnish of soft poly(vinyl butyral) and additional plasticizer to one or more of sedimentation, filtration, centrifugation, evaporation, or precipitation to isolate the soft poly(vinyl butyral).

19. The process of claim 1, further comprising adding the varnish of soft poly(vinyl butyral) and additional plasticizer to a poly(vinyl butyral) composition.

20. The process of claim 19, further comprising forming the poly(vinyl butyral) composition into a sheet.

21. The process of claim 1, further comprising adding the varnish of soft poly(vinyl butyral) and additional plasticizer to a poly(vinyl butyral) composition comprising a whitener to form a translucent interlayer.

22. The process of claim 1, further comprising adding the varnish of soft poly(vinyl butyral) and additional plasticizer to a clear poly(vinyl butyral) formulation.

23. A poly(vinyl butyral) sheet comprising the isolated soft poly(vinyl butyral) of claim 18.

24. A laminated glass comprising the poly(vinyl butyral) sheet of claim 20.

25. A poly(vinyl butyral) sheet comprising the separated granulate enriched in the stiff poly(vinyl butyral) of claim 1.

26. A laminated glass comprising the poly(vinyl butyral) sheet of claim 1.
